(19) United States
(12) Patent Application Publication
(10) Pub. No.: US 2008/0295255 A1
(43) Pub. Date: Dec. 4, 2008

(54) TOOL HOLDER

(76) Inventor: Edward O. Whitehead, Dearborn Heights, MI (US)

Correspondence Address: MILLER, CANFIELD, PADDOCK AND STONE;MARJORY G. BASILE, ESQ., 150 W. JEFFERSON, SUITE 2500, DETROIT, MI, 48226, US

(21) Appl. No.: 11/755,091

(22) Filed: May 30, 2007

(51) Int. Cl. B25F 1/00

(52) U.S. Cl. 7/167

(57) ABSTRACT

A tool holder for a tool comprises a left side flange and a right side flange which cooperate to define a base and a thumb surface. The base has a slot which is adapted to receive the tool. A vertical flange extends generally perpendicular to the base and the vertical flange defines a ring portion having an opening adapted to receive a finger. The left side flange, right side flange and vertical flange are formed from an elastomeric material and as a unitary construction. The base has a slot adapted to receive the tool and the slot has a cross section which is less than a cross section of the tool which results in an interference fit securing the tool to the tool holder

### FIELD OF THE INVENTION

This invention relates to tool holders, and more particularly to improved tool holders for enhancing the comfort of a user of a handheld tool.

### BACKGROUND OF THE INVENTION

Numerous types of tools, including knives, pens, files, screwdrivers, awls, punches, etc., may have a handle or holder which receives a hand of an operator. The holder is supposed to make use of the tool more comfortable. Various tool holder devices are known which attempt to address various concerns such as increasing user comfort, allowing for multiple tools to be used, etc. For example, U.S. Pat. No. 1,980,087 to Rast discloses a multi-part, screwed together tool handle which is adapted to receive a tool. However, such a handle is not particularly ergonomic, a problem that increases with tools that require extended use. U.S. Pat. No. 6,328,494 to Moxon discloses a molded grip and a separate rod which may be attached to the grip which forms a finger holder. Although the tool holder of Moxon is universal for both left and right hands, it is still relatively unergonomic and relatively complex. It would be desirable to provide a tool holder which is comfortable for those that use tools for extended periods of time, which is of low cost construction, and which is easy to attach to the tool.

### SUMMARY OF THE INVENTION

In accordance with a first aspect, a tool holder for a tool comprises a left side flange and a right side flange which cooperate to define a base and a thumb surface. The base has a slot which is adapted to receive the tool. A vertical flange extends generally perpendicular to the base and the vertical flange defines a ring portion having an opening adapted to receive a finger. The left side flange, right side flange and vertical flange are formed from an elastomeric material and as a unitary construction. In accordance with another aspect, the base has a slot adapted to receive the tool and the slot has a cross section which is less than a cross section of the tool which results in an interference fit securing the tool to the tool holder.

From the foregoing disclosure and the following more detailed description of various preferred embodiments it will be apparent to those skilled in the art that the present invention provides a significant advance in the technology and art of tool holders. Particularly significant in this regard is the potential the invention affords for providing a high quality, comfortable and low cost tool holder. Additional features and advantages of various preferred embodiments will be better understood in view of the detailed description provided below.

### BRIEF DESCRIPTION OF THE DRAWINGS

FIG. 1 is a perspective view of a tool holder in accordance with a preferred embodiment with the tool shown in phantom for completeness of illustration.

FIG. 2 is a top side view of the tool holder of FIG. 1.

FIG. 3 is a front side view of the tool holder of FIG. 1

FIG. 4 is a right side view of the tool holder of FIG. 1.

FIG. 5 is a rear side view of the tool holder of FIG. 1.

FIG. 6 is a bottom side view of the tool holder of FIG. 1.

FIG. 7 is a perspective view of a tool holder in accordance with another preferred embodiment with the tool shown in phantom for completeness of illustration.

FIG. 8 is a top side view of the tool holder of FIG. 7.

FIG. 9 is a front side view of the tool holder of FIG. 7.

FIG. 10 is a right side view of the tool holder of FIG. 7.

FIG. 11 is a rear side view of the tool holder of FIG. 7.

FIG. 12 is a bottom side view of the tool holder of FIG. 7.

FIG. 13 is a perspective view of the tool holder of FIG. 1, shown grasped by a hand.

It should be understood that the appended drawings are not necessarily to scale, presenting a somewhat simplified representation of various preferred features illustrative of the basic principles of the invention. The specific design features of the tool holder as disclosed here will be determined in part by the particular intended application and use environment. Certain features of the illustrated embodiments have been enlarged or distorted relative to others to help visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the tool holder disclosed here. The following detailed discussion of various alternative and preferred features and embodiments will illustrate the general principles of the invention with reference to a tool holder suitable for use with a cutting tool such a as a knife. Other embodiments suitable for other applications will be apparent to those skilled in the art given the benefit of this disclosure.

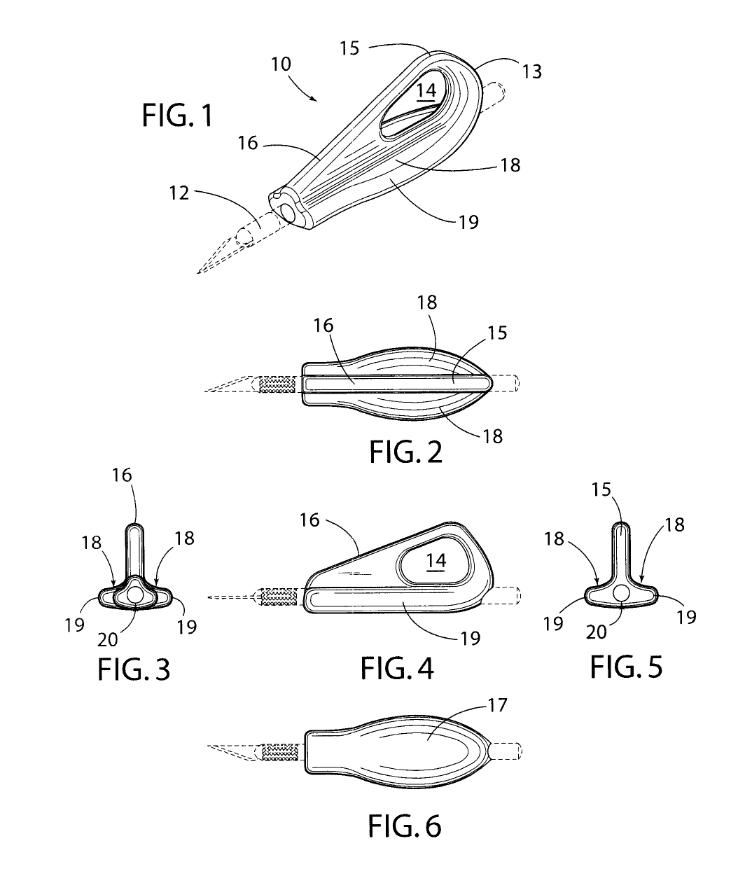

Referring now to the drawings, FIGS. 1-6 show a tool holder 10 in accordance with a preferred embodiment having left and right side flanges 19 and a vertical flange 16 positioned generally on top of and between the left and right side flanges. The left and right flanges 19 are generally parallel and coplanar to one another and form a base with a slot 20 extending along a length of the tool holder 10 from one end to the other end. As shown in the Figs. the vertical flange 16 extends generally perpendicular to the base, so that the tool holder is generally T-shaped as viewed from one end to the other. Each of the flanges runs generally the entire length of the tool holder, although one or more of these flanges may be shortened if desired. Generally underneath the vertical flange 16 is a slot 20 adapted to receive a tool such as a pen or, as shown here in phantom, a knife 12. Rising segment 15 of the vertical flange 16 defines a ring with opening 14. The opening 14 is sized to receive an index finger of a human hand. Side flanges 19 each have a surface 18 adapted to receive the index finger (left hand index finger on one side, right hand index finger on the other side) which has extended through the opening. The surfaces 18 may be slightly curved to comfortably receive a finger. The side flanges 19 cooperate to define a thumb surface 17 (shown in FIG. 6). The thumb surface 17 and the surfaces 18 (which can receive a finger) are preferably generally parallel to one another, as shown in the Figs. The thumb surface is generally opposite the vertical flange, in the sense of direction shown in the Figs. FIG. 13 shows the tool holder 10 with a knife held by a right hand, with the right index finger extending through the opening and the thumb contacting the thumb surface.

In accordance with a highly advantageous feature, the vertical flange 16 and the left and right flanges 19 all preferably comprise a one-piece or unitary construction. No additional screws or other fasteners are required. Most preferably, the tool holder comprises a resiliently deformable elastomeric material such as a rubber. A resiliently deformable elastomer is highly advantageous, not only because it is comfortable to the user of the tool, but also because the slot 20 may have a cross section or diameter sized slightly smaller than the cross section or diameter of a tool, so that the tool may be releasably attached to the tool holder by interference fit. The interference fit holds the tool in place with respect to the tool holder as it is used. The tool can be removed from the tool holder by overcoming the biasing force of the tool holder on the tool.

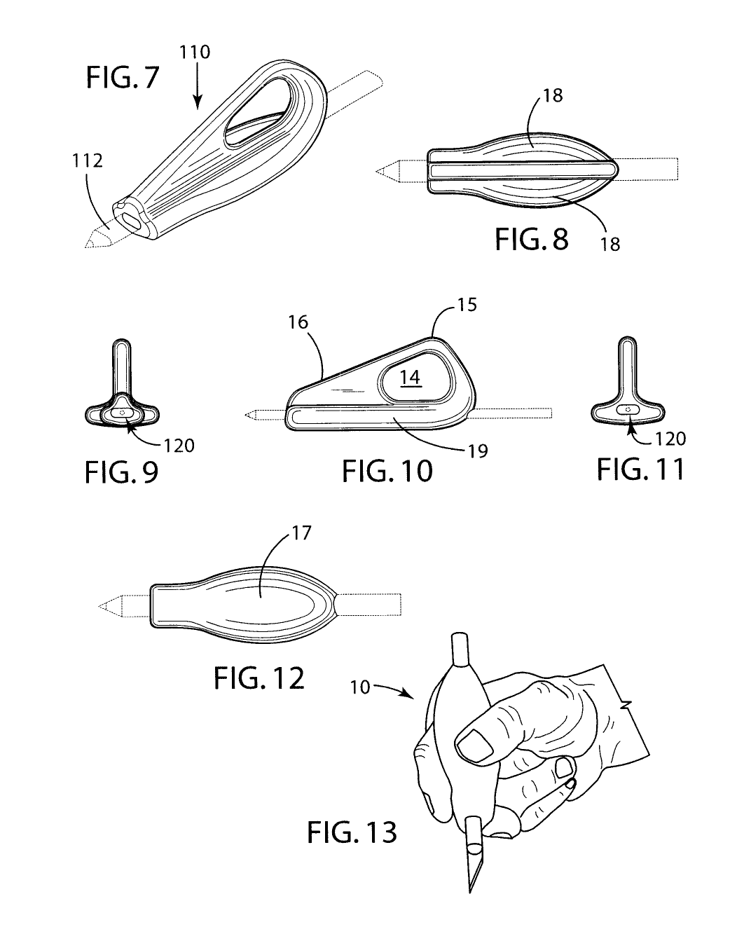

The tool itself may have a cylindrical cross section, or some other cross section, such as hexagonal or square, for example. The resiliently deformable tool holder will fit snugly around the tool regardless of cross section, and the slot may be modified if desired. FIGS. 7-12 show and alternate preferred embodiment of a tool holder 110 where the tool is a pencil 112 shown in phantom that has a generally flattened cylindrical cross section. Slot 120 also has a generally flattened cylindrical cross section, instead of the circular cross section of slot 20 in the previous embodiment. Left and right side flanges 19, surfaces 18 and 17, and vertical flange 16 all remain essentially the same as the previous embodiment.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A tool holder for a tool comprising, in combination:
a left side flange and a right side flange cooperating to define a base and a thumb surface, wherein the base has a slot which is adapted to receive the tool; and
a vertical flange extending generally perpendicular to the base, wherein the vertical flange defines a ring portion having an opening adapted to receive a finger;
wherein the left side flange, right side flange and vertical flange are formed from an elastomeric material and as a unitary construction.

2. The tool holder of claim 1 wherein the slot has a cross section which is less than a cross section of the tool resulting in an interference fit releasably securing the tool to the tool holder.

3. The tool holder of claim 1 wherein the left side flange and right side flange each define a surface adapted to receive a finger, and the side flanges cooperate to define a thumb surface adapted to receive a thumb.

4. The tool holder of claim 1 wherein the thumb surface is opposite the vertical flange.

5. A tool holder for a tool comprising, in combination:
a left side flange and a right side flange cooperating to define a base and a thumb surface, the base has a slot adapted to receive the tool, the slot has a cross section which is less than a cross section of the tool, resulting in an interference fit securing the tool to the tool holder; and
a vertical flange extending generally perpendicular to the base, wherein the vertical flange defines a ring portion having an opening adapted to receive a finger;
wherein the left side flange, right side flange and vertical flange are formed from an elastomeric material.

6. The tool holder of claim 5 wherein the left side flange and right side flange each define a surface adapted to receive a finger, and the side flanges cooperate to define a thumb surface adapted to receive a thumb.
